(19) United States
(12) Patent Application Publication
(10) Pub. No.: US 2008/0273228 A1
(43) Pub. Date: Nov. 6, 2008

(54) IMAGE READING APPARATUS AND CONTROL METHOD THEREFOR

(75) Inventors: Toshiyuki Takano, Toride-shi (JP); Tomohito Nakagawa, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/101,613

(22) Filed: Apr. 11, 2008

(30) Foreign Application Priority Data
May 1, 2007 (JP) 2007-120979

(51) Int. Cl. H04N 1/04

(52) U.S. Cl. 358/497

(57) ABSTRACT

An image reading apparatus comprises a document positioning plate configured to place a document thereon, a pressing plate configured to press the document on the document positioning plate, a reading unit configured to read an image of the document placed on the document positioning plate, a display unit provided on the pressing plate, and a size detecting unit configured to detect a size of the document placed on the document positioning plate based on a first image obtained by illuminating the display unit in a light color and reading the document positioning plate with the reading unit and a second image obtained by illuminating the display unit in a dark color and reading the document positioning plate with the reading unit.

### BACKGROUND OF THE INVENTION

1. Field of the Invention

The present invention relates to an image reading apparatus for use in an image forming apparatus, such as a copying machine, a printer, and a facsimile and also relates to a control method for the image reading apparatus.

2. Description of the Related Art

Conventionally, various techniques have been proposed for detecting a size of a document placed on a document positioning plate of an image reading apparatus, as described below.

Japanese Patent Application Laid-Open No. 03-002858 discusses an image reading apparatus configured such that a plurality of document detecting sensors are provided on an underside of a document positioning plate, each document detecting sensor including a light-emitting unit that emits light to a document on the document positioning plate and a light receiving unit that receives the light emitted by the light-emitting unit. The image reading apparatus detects the presence or absence of a document from a plurality of detection points by the document detecting sensors, and detect the size of the document placed on the document positioning plate by a combination of the document detecting sensors which are detecting the presence of the document.

Japanese Patent Application Laid-Open No. 04-229850 (corresponding to U.S. Pat. No. 5,122,833) discusses a technique for forming a mirror surface on an underside surface of a pressing plate that presses a document on a document positioning plate, and detecting a document size by using information read by optical scanning of the document. That is, since the underside surface of the pressing plate is a mirror surface, the area other than the document is read as black, so that the edges of document can be detected.

However, in the Japanese Patent Application Laid-Open No. 03-002858, it is a precondition that a document properly abuts on a predetermined abutting portion. If the document inappropriately abuts, combinations of a plurality of detection points vary, therefore, an accurate document size cannot be detected. Furthermore, if the detection of a document size is not carried out when a pressing member is open in conjunction with detection of opening/closing of the pressing member, it may be impossible to discriminate between the white pressing member and the document and may cause false size detection.

In edge detection by a pressing plate having the mirror surface discussed in the Japanese Patent Application Laid-Open No. 04-229850, there is a problem that if a background color of a document edge is black, false detection can occur because the pressing plate has the mirror-surface.

Under such situation, there is a desire to provide a document reading apparatus that is capable of securely detecting a size, position and orientation of a document, and automatically correcting a reading position, which improves operability.

### SUMMARY OF THE INVENTION

An embodiment of the present invention is directed to an image reading apparatus capable of detecting a size of a document placed on a document positioning plate thereof and correcting a reading position, including skew image correction when a document is positioned askew. According to an aspect of an embodiment, the document size detection and the skew image correction can be accomplished regardless of whether in a document, placed on the document positioning plate, has a white background color, a black background color, or a combination thereof.

According to an aspect of the present invention, an image reading apparatus includes a document positioning plate configured to place a document thereon, a pressing plate configured to press the document on the document positioning plate, a reading unit configured to read an image of the document placed on the document positioning plate, a display unit provided on a document contact surface of the pressing plate, and a size detecting unit configured to detect a size of the document placed on the document positioning plate based on a first image obtained by illuminating the display unit in a light color and reading an area wider than the document with the reading unit and a second image obtained by illuminating the display unit in a dark color and reading an area wider than the document with the reading unit.

According to another aspect of the present invention, an image reading apparatus includes a document positioning plate configured to place a document thereon, a pressing plate configured to press the document on the document positioning plate, a reading unit configured to read an image of the document placed on the document positioning plate, a display unit provided on a document contact surface of the pressing plate, and a skew correction unit configured to correct skew of a document image based on a first image obtained by illuminating the display unit in a light color and reading an area wider than the document with the reading unit and a second image obtained by illuminating the display unit in a dark color and reading an area wider than the document with the reading unit.

According to yet another aspect of the present invention, a method for controlling an image reading apparatus having a document positioning plate configured to place a document thereon, a pressing plate configured to press the document on the document positioning plate, a reading unit configured to read an image of the document placed on the document positioning plate, and a display unit provided on a document contact surface of the pressing plate, the method including obtaining a first image by illuminating the display unit in a light color and reading an area wider than the document with the reading unit, obtaining a second image by illuminating the display unit in a dark color and reading an area wider than the document with the reading unit, and detecting a size of the document placed on the document positioning plate based on the first image and the second image.

According to yet another aspect of the present invention, a method for controlling an image reading apparatus having a document positioning plate configured to place a document thereon, a pressing plate configured to press the document on the document positioning plate, a reading unit configured to read an image of the document placed on the document positioning plate, and a display unit provided on a document contact surface of the pressing plate, the method including obtaining a first image by illuminating the display unit in a light color, reading an area wider than the document with the reading unit, obtaining a second image by illuminating the display unit in a dark color and reading an area wider than the document with the reading unit, and correcting skew of a document image based on the first image and the second image.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an example configuration diagram of an image reading apparatus according to an embodiment of the present invention.

FIG. 2 is an example block diagram of a control system for an image reading apparatus according to an exemplary embodiment of the present invention.

FIG. 3 is an example of a structural cross sectional view of electronic paper in FIG. 1.

FIG. 4 is operation principle diagrams of the electronic paper in FIG. 1.

FIG. 5 illustrates an open state of a pressing plate of the image reading apparatus in FIG. 1.

FIG. 6 illustrates another open state of the pressing plate of the image reading apparatus in FIG. 1.

FIG. 7 illustrates an example of an image of a document in FIG. 1.

FIG. 8 illustrates a first image obtained by reading the document in FIG. 7.

FIG. 9 illustrates a second image obtained by reading the document in FIG. 7.

FIG. 10 illustrates a third image obtained by an exclusive OR between the first image and the second image.

FIG. 11 is a flowchart illustrating an image reading process which is executed by the image reading apparatus in FIG. 2.

### DETAILED DESCRIPTION OF THE EMBODIMENTS

Exemplary embodiments of the present invention will be described in detail below with reference to the drawings.

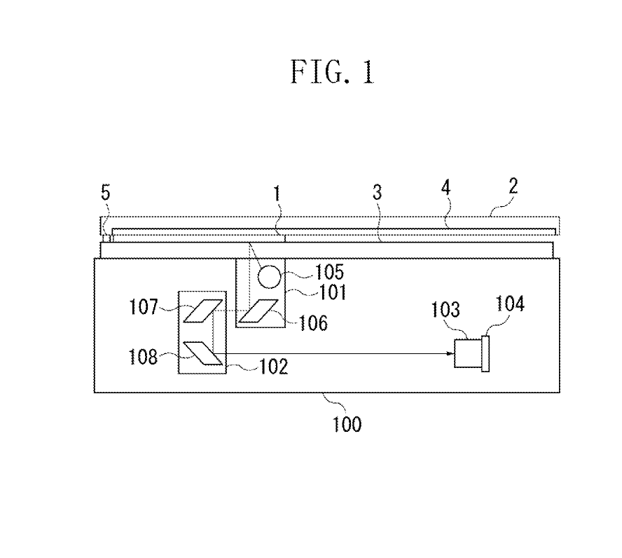

FIG. 1 is a configuration diagram of an image reading apparatus according to an exemplary embodiment of the present invention.

In FIG. 1, the image reading apparatus includes an apparatus main body 100, a pressing plate 2 located on an upper part of the apparatus main body 100, and a document positioning plate 3 which is fixed to the upper surface of the apparatus main body 100 and is opened and closed by the pressing plate 2. The pressing plate 2 contacts with the upper surface of the document positioning plate 3 to prevent paper from floating from the document positioning plate 3.

When a document 1 is placed on the document positioning plate 3, a user opens the pressing plate 2, places the document 1 with the front side facing the document positioning plate 3 side, closes the pressing plate 2, and the image is read.

Electronic paper (a display unit) 4 is attached to a surface of the pressing plate 2 which contacts the document 1 (a document contact surface). The electronic paper 4 is arranged to cover the document positioning plate 3. In addition, a pressing plate opening/closing sensor 5 is arranged at an edge of the document positioning plate 3.

The configuration of the apparatus main body 100 is described below.

The apparatus main body 100 includes a first optical bench 101, a second optical bench 102, a lens 103, and a charge coupled device (CCD) 104. The first optical bench 101 includes a lamp 105 and a mirror 106. The second optical bench 102 includes mirrors 107 and 108. The first optical bench 101 and the second optical bench 102 constitute a reading unit.

Reflected light from the document 1 which corresponds to light emitted from the lamp 105 is guided through the mirrors 106 to 108 to the lens 103 and the CCD 104. The CCD 104 photoelectrically converts the reflected light carrying information from the document, and outputs an electronic image signal.

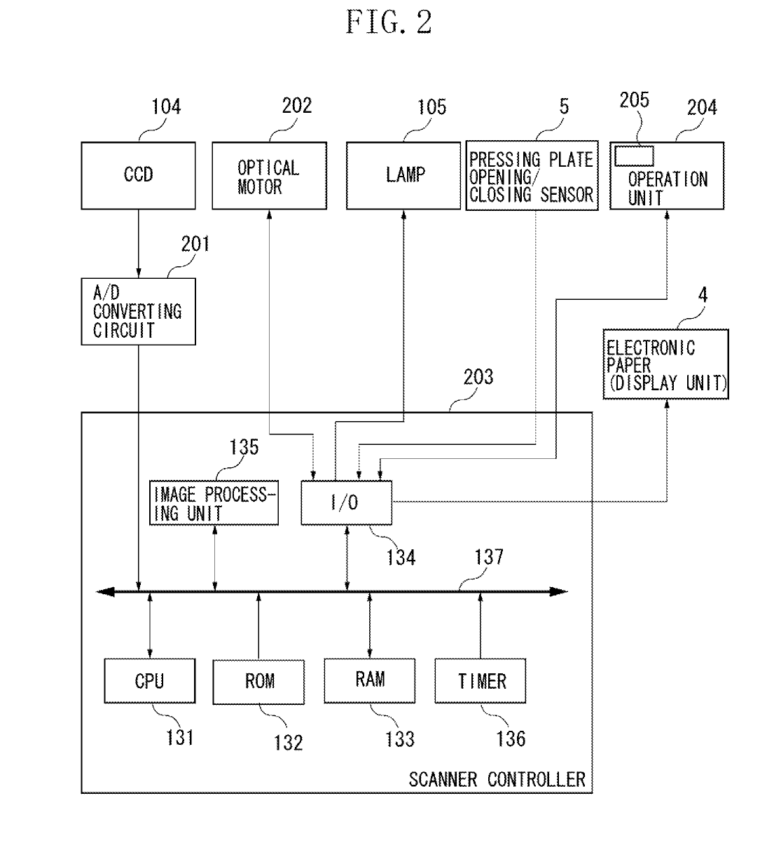

The first optical bench 101 and the second optical bench 102 are connected to an optical motor 202 (FIG. 2) by wires (not shown) and are controlled to move in parallel with the document positioning plate 3 by rotating drive of the optical motor 202. The first optical bench 101 and the second optical bench 102 are moved in the forward direction (read direction) and the backward direction (return direction) by normal rotation and backward rotation of the optical motor 202.

FIG. 2 is a block diagram of the control system for an image reading apparatus according to an exemplary embodiment of the present invention.

In FIG. 2, the image reading apparatus includes an analog-to-digital (A/D) converting circuit 201, the optical motor 202, a scanner controller 203, and an operation unit 204 in addition to the electronic paper (display unit) 4, the pressing plate opening/closing sensor 5, the CCD 104, and the lamp 105.

The scanner controller 203 includes a central processing unit (CPU) 131, a read-only memory (ROM) 132, a random access memory (RAM) 133, an input/output (I/O) interface 134, an image processing unit 135 and a timer 136 which are mutually connected via a bus 137.

The I/O interface 134 is connected with the optical motor 202, the lamp 105 which is controlled to turn on and off by the scanner controller 203, the pressing plate opening/closing sensor 5, the operation unit 204 including a copy button 205, and the electronic paper 4. The CCD 104 is connected to the bus 137 in the scanner controller 203 via the A/D converting circuit 201.

The scanner controller 203 recognizes that the document have been changed with the pressing plate opening/closing sensor 5 when an image of the document 1 is read, and turns on the lamp 105 and drives the optical motor 202 when the copy button 205 is pressed. Furthermore, the scanner controller 203 moves the first optical bench 101 and the second optical bench 102 in a sub-scanning direction along the document 1.

The reflected light from the document 1 which is obtained by scanning the document 1 is passed through the lens 103 and focused on the CCD 104. An optical output read by the CCD 104 is converted into a digital signal by the A/D converting circuit 201 and then sent as image data to the scanner controller 203.

The scanner controller 203 transfers the received image data to its image processing unit 135, and outputs the image on a printer (not shown) based on image data processed in the image processing unit 135.

The display operation of the electronic paper 4 is described below.

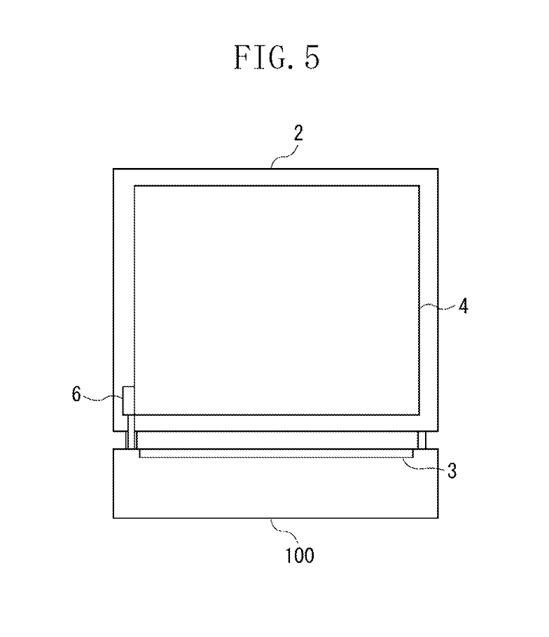

The electronic paper 4 is, for example, a thin display unit configured as a substrate by using a resin. A processing unit 6 (FIG. 5) is provided on a portion of the electronic paper 4 that occupies a large area of the pressing plate 2. The electronic paper 4 is thin and flexible, so that it is sufficiently resistible to elastic deformation when the electronic paper 4 presses the document 1.

The processing unit 6 includes a driver to drive the electronic paper 4, a communication unit to communicate with the outside, a memory to store electronic data which is freely readable and writable, a processor to execute various processes, and a battery to supply electric power for driving the communication unit, the processor, etc., that are not shown.

By communicating with external devices having a communication function, the electronic paper 4 can send and receive electronic data (e.g., image data) and store the electronic data in the memory.

Further, the electronic paper 4 enables the driver to write images based on data stored in the memory and maintain image information in a display state even if electric power for driving the driver is removed.

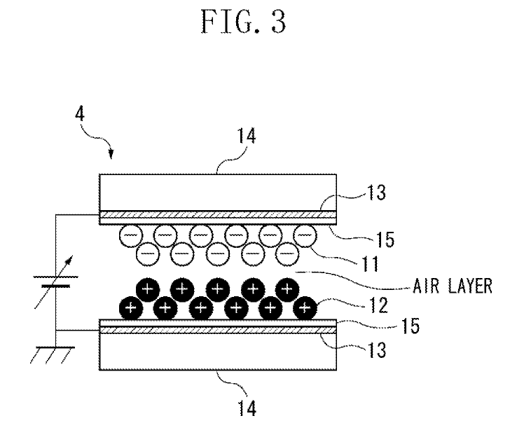

FIG. 3 is a structural cross sectional view of the electronic paper 4 in FIG. 1.

As shown in FIG. 3, in the electronic paper 4, fine color particles used as toner for copying machines (white-color particles 11 and black-color particles 12 in the illustrated example) are enclosed between a pair of a front and a rear electrode layers 13, in which at least the front-side electrode is transparent. Further, the electrode layers 13 are sandwiched by a pair of a front and a rear film substrates 14, in which at least the front-side substrate is transparent.

Between the electrode layers 13, an air layer is provided to enable the white-color particles 11 and the black-color particles 12 to move freely. The matrix-state electrode layers 13 are each covered with an insulating layer 15 to prevent them from contacting color particles 11 and 12.

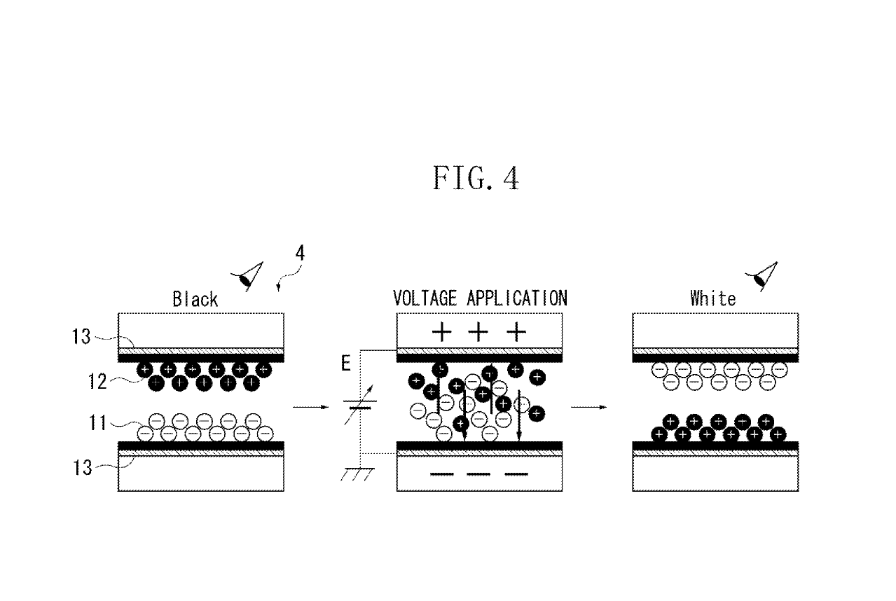

FIG. 4 is the operation principle diagram of the electronic paper 4 in FIG. 1.

In FIG. 4, under a condition that a voltage is not applied to the electrode layers 13 (however, the electrode layers 13 are charged with the polarities at the time that the electronic paper was last driven), negatively (minus) charged white-color particles 11 accumulate on the rear side. On the other hand, positively (plus) charged black-color particles 12 accumulate on the front side, so that if the electronic paper 4 is seen from the front side, the electronic paper 4 appears in black color.

Even when the electronic paper 4 is operated based on data stored in the memory, if the electrode polarities of selected portions of the matrix corresponding to image information to be displayed are reversed, the positional relationship between the white-color particles 11 and the black-color particles 12 is changed over. Therefore, the electronic paper 4 displays image information by contrast of the white-color particles 11 and the black-color particles 12.

By operating the electronic paper 4 based on different data, it is possible to change over image information displayed on the electronic paper 4 by contrast of the white-color particles 11 and the black-color particles 12, and this function can be used over and over again.

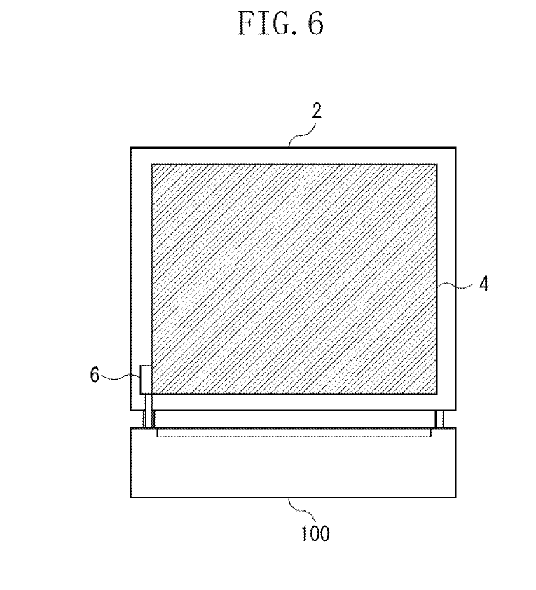

FIG. 5 illustrates an open state of the pressing plate 2 of the image reading apparatus in FIG. 1. FIG. 6 illustrates another open state of the pressing plate 2 of the image reading apparatus in FIG. 1.

In FIG. 5, the pressing plate 2 is connected to a back of the apparatus by hinges to freely open and close. The electronic paper 4 attached to the pressing plate 2 normally displays an entire screen in white (a light color) as a background for the document 1. Meanwhile, as shown in FIG. 6, the electronic paper 4 on the pressing plate 2 can also display the entire screen in black (a dark color). Though this is not shown, the electronic paper 4 is, as its characteristics, capable of displaying images and letters and reading displayed images together with the document.

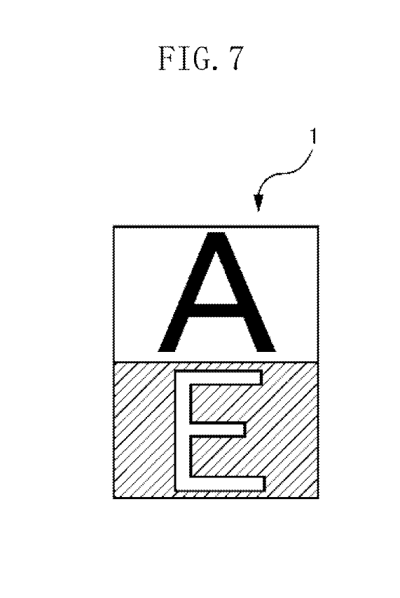

FIG. 7 illustrates an example of an image of the document 1 in FIG. 1.

When the document 1 with an image shown in FIG. 7 (having “A” in an upper white ground and “E” in a lower black ground with no marginal blank space) is read, it is possible to accurately read only the image of the document even if the document is placed askew on the document positioning plate 3.

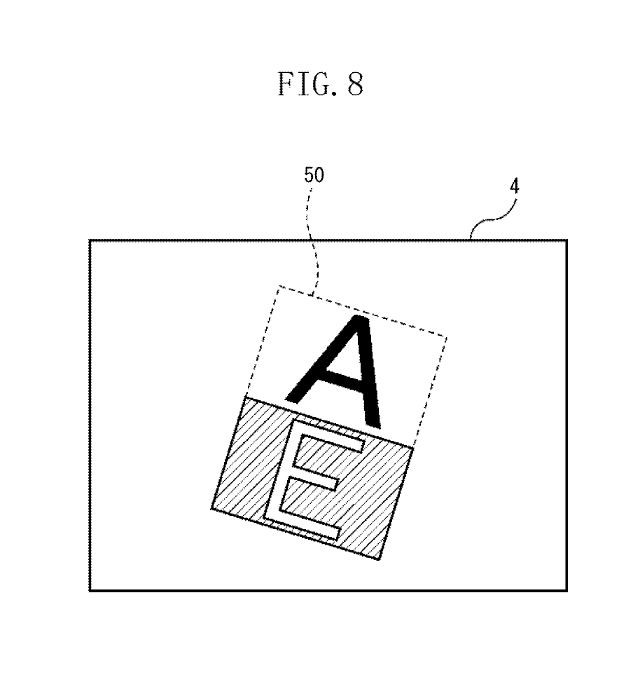

As a default, an entire screen of the electronic paper 4 is displayed in white, the image is read (input) once, and a first image 50 in FIG. 8 is stored in a RAM 133. An area (range) to be read includes the pressing plate 2, and is wider than the document 1.

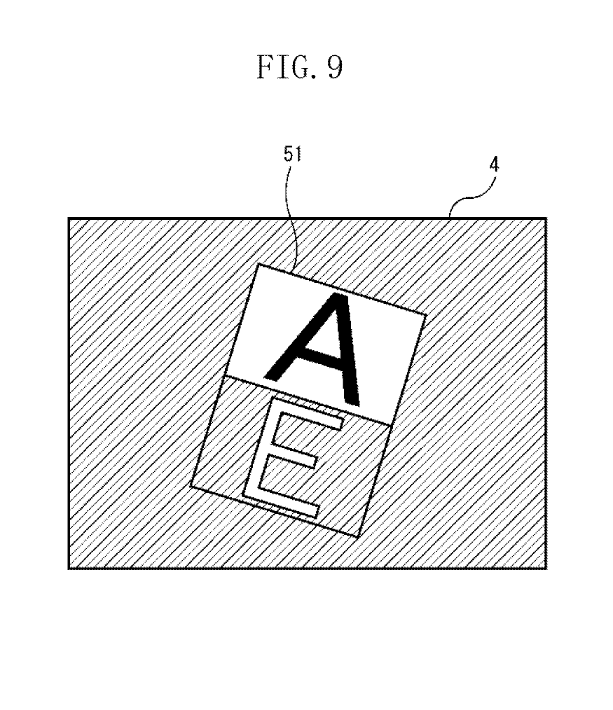

The first image 50 in FIG. 8 is indistinct at edges of the document because the background color around the upper “A” is white and the color of the pressing plate 2 (electronic paper 4) is white. In the next reading, the electronic paper 4 displays black on the entire area of the screen and a second image 51 in FIG. 9 is stored in the RAM 133.

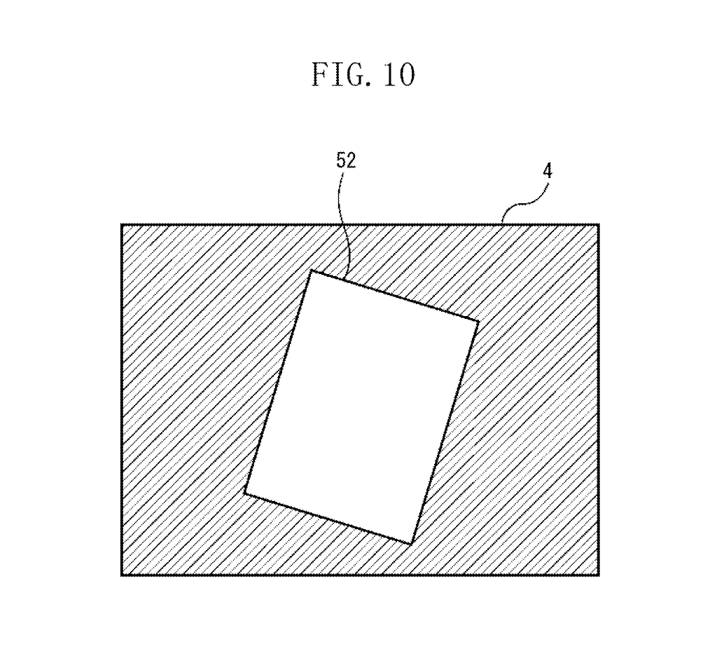

In the second image 51 in FIG. 9, since the color of the pressing plate 2 (electronic paper 4) is black, the edges of the image of “A” are distinct due to the high contrast of color. Finally, the image processing unit 135 performs an exclusive OR between the image in FIG. 8 and the image in FIG. 9 and obtains a third image 52 as shown in FIG. 10.

By detecting the edges of the third image 52 in FIG. 10, it is possible to determine an accurate size of the document 1 and accurately extract only a document image. Above all, even if there is no marginal blank space or images close to black (a photographic image with a night scene in the background, for example) are mixed, it is possible to detect a precise document size. Further, it is possible to accurately extract a document image even when the document is placed askew and scanned.

In this exemplary embodiment, it is assumed that the first image 50 is in white or a light color and the second image 51 is in black or a dark color, but even if this order is reversed, the same effect can be obtained. The light color and the dark color are not limited to white and black, and if two colors that have high contrast are used, the same effect can be obtained.

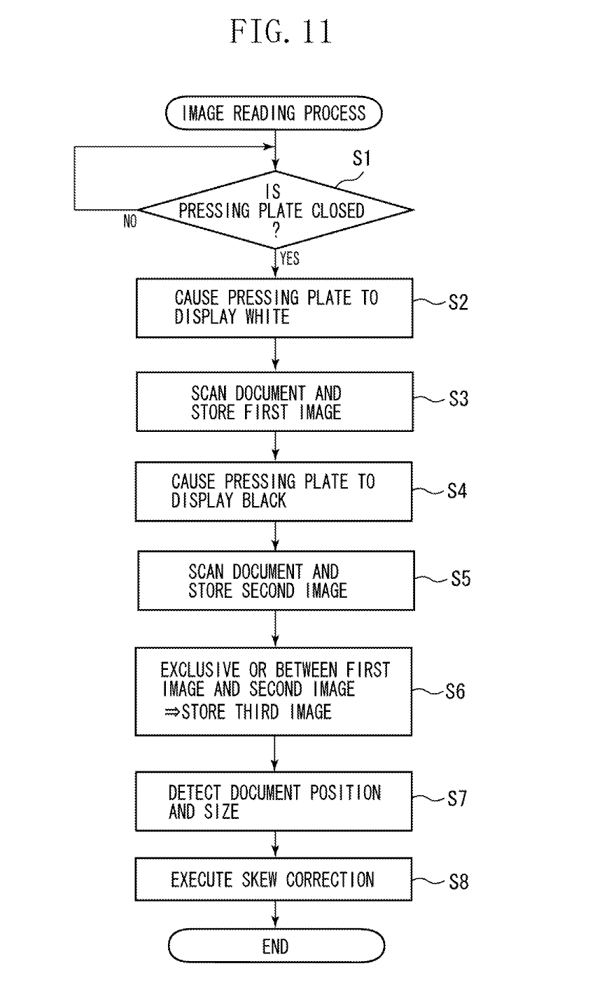

FIG. 11 is a flowchart illustrating a procedure of an image reading process which is executed by the image reading apparatus in FIG. 2.

This process is executed by the CPU 131 in FIG. 2.

In step S1, the CPU 131 determines whether a user has closed the pressing plate 2 and pressed copy button (read start button) 205. If it is determined that the pressing plate 2 is closed and the copy button (read start button) 205 is pressed (YES in step S1), in step S2, the CPU 131 causes the electronic paper 4 on the pressing plate 2 to display white color. In step S3, the CPU 131 performs a first scanning operation to obtain a first image 50 shown in FIG. 8.

In step S4, the CPU 131 causes the electronic paper 4 on the pressing plate 2 to display black color. In step S5, the CPU 131 performs a second scanning operation to obtain a second image 51 shown in FIG. 9.

In step S6, the CPU 131 compares the first image 50 with the second image 51 to obtain a third image 52 shown in FIG. 10 as an image obtained by an exclusive OR. In step S7, the CPU 131 determines edges of a white and a black areas by the image processing unit 135 and detects a position (askew or not) and a size of a document 1. In step S8, the CPU 131 causes the image processing unit 135 to correct skew of the document 1 based on the edges of the third image 52 and this process is finished.

The skew correction of the document 1 is executed by the image processing unit 135. The image processing unit 135 rotates an image input from the scanner controller 203 in order to correct the skew of the document 1.

In a document reading operation, a first image 50 is read in a forward motion of the first optical bench 101 and the second optical bench 102 that constitute the reading unit, and a second image 51 is read in a backward motion of those optical benches 101 and 102, so that a document size can be detected and skew images can be corrected without reducing reading productivity.

As described above, according to an embodiment of the present invention, it is possible to provide an image reading apparatus capable of securely detecting a size of a document and correcting a reading position, including image skew correction, regardless whether in a document, a white background color and a black background color are mixed, and a document positioned is askew.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2007-120979 filed May 1, 2007, which is hereby incorporated by reference herein in its entirety.

What is claimed is:

1. An image reading apparatus comprising:
a document positioning plate configured to place a document thereon;
a pressing plate configured to press the document on the document positioning plate;
a reading unit configured to read an image of the document placed on the document positioning plate;
a display unit provided on the pressing plate; and
a size detecting unit configured to detect a size of the document placed on the document positioning plate based on a first image obtained by illuminating the display unit in a light color and reading the document positioning plate with the reading unit and a second image obtained by illuminating the display unit in a dark color and reading the document positioning plate with the reading unit.

2. The apparatus according to claim 1, wherein the display unit is provided on the pressing plate such that when the pressing plate is in a closed position, a display screen of the display unit faces the document placed on the document positioning plate.

3. The apparatus according to claim 2, wherein the light color is a white color, and the first image is obtained by using the display unit to display the display screen thereof in the white color and reading the document placed on the document positioning plate and a portion of the display screen displayed in the white color that is not covered by the document with the reading unit; and
wherein the dark color is a black color, and the second image is obtained by using the display unit to display the display screen thereof in the black color and reading the document placed on the document positioning plate and a portion of the display screen displayed in the black color that is not covered by the document with the reading unit.

4. The image reading apparatus according to claim 1, wherein the display unit includes electronic paper.

5. The image reading apparatus according to claim 1, wherein the size detecting unit detects the document size by detecting an edge of a third image obtained by an exclusive OR between the first image and the second image.

6. The image reading apparatus according to claim 1, wherein the light color includes a white color and the dark color includes a black color.

7. The image reading apparatus according to claim 1, wherein the reading unit reads the first image in its forward motion and the second image in its backward motion.

8. An image reading apparatus comprising:
a document positioning plate configured to place a document thereon;
a pressing plate configured to press the document on the document positioning plate;
a reading unit configured to read an image of the document placed on the document positioning plate;
a display unit provided on the pressing plate; and
a skew correcting unit configured to correct skew of a document image based on a first image obtained by illuminating the display unit in a light color and reading the document positioning plate with the reading unit and a second image obtained by illuminating the display unit in a dark color and reading the document positioning plate with the reading unit.

9. The apparatus according to claim 8, wherein the display unit is provided on the pressing plate such that when the pressing plate is in a closed position, a display screen of the display unit faces the document placed on the document positioning plate.

10. The apparatus according to claim 9, wherein the light color is a white color, and the first image is obtained by using the display unit to display the display screen thereof in the white color and reading the document placed on the document positioning plate and a portion of the display screen displayed in the white color that is not covered by the document with the reading unit; and
wherein the dark color is a black color, and the second image is obtained by using the display unit to display the display screen thereof in the black color and reading the document placed on the document positioning plate and a portion of the display screen displayed in the black color that is not covered by the document with the reading unit.

11. The image reading apparatus according to claim 8, wherein the display unit includes electronic paper.

12. The image reading apparatus according to claim 8, wherein the skew correcting unit corrects the skew of the document image by detecting an edge of a third image obtained by an exclusive OR between the first image and the second image.

13. The image reading apparatus according to claim 8, wherein the light color includes a white color and the dark color includes a black color.

14. The image reading apparatus according to claim 8, wherein the reading unit reads the first image in its forward motion and the second image in its backward motion.

15. The image reading apparatus according to claim 1, wherein the display unit is disposed on a document contact surface of the pressing plate.

16. A method for controlling an image reading apparatus comprising a document positioning plate configured to place a document thereon; a pressing plate configured to press the document on the document positioning plate; a reading unit configured to read an image of the document placed on the document positioning plate; and a display unit provided on the pressing plate, the method comprising:
obtaining a first image by illuminating the display unit in a light color and reading the document positioning plate with the reading unit;
obtaining a second image by illuminating the display unit in a dark color and reading the document positioning plate with the reading unit; and
detecting a size of the document placed on the document positioning plate based on the first image and the second image.

17. The method according to claim 16, wherein the display unit is provided on the pressing plate such that when the pressing plate is in a closed position, a display screen of the display unit faces the document placed on the document positioning plate.

18. The method according to claim 17, wherein the light color is a white color, and the first image is obtained by using the display unit to display the display screen thereof in the white color and reading the document placed on the document positioning plate and a portion of the display screen displayed in the white color that is not covered by the document with the reading unit; and
wherein the dark color is a black color, and the second image is obtained by using the display unit to display the display screen thereof in the black color and reading the document placed on the document positioning plate and a portion of the display screen displayed in the black color that is not covered by the document with the reading unit.

19. A method for controlling an image reading apparatus comprising a document positioning plate configured to place a document thereon; a pressing plate configured to press the document on the document positioning plate; a reading unit configured to read an image of the document placed on the document positioning plate; and a display unit provided on the pressing plate, the method comprising:
obtaining a first image by illuminating the display unit in a light color and reading the document positioning plate with the reading unit;
obtaining a second image by illuminating the display unit in a dark color and reading the document positioning plate with the reading unit; and
correcting skew of a document image based on the first image and the second image.

20. The method according to claim 19, wherein the display unit is provided on the pressing plate such that when the pressing plate is in a closed position, a display screen of the display unit faces the document placed on the document positioning plate.

21. The method according to claim 20, wherein the light color is a white color, and the first image is obtained by using the display unit to display the display screen thereof in the white color and reading the document placed on the document positioning plate and a portion of the display screen displayed in the white color that is not covered by the document with the reading unit; and
wherein the dark color is a black color, and the second image is obtained by using the display unit to display the display screen thereof in the black color and reading the document placed on the document positioning plate and a portion of the display screen displayed in the black color that is not covered by the document with the reading unit.
